(19) United States
(12) Patent Application Publication
(10) Pub. No.: US 2002/0098836 A1
(43) Pub. Date: Jul. 25, 2002

(54) Switching of one or more ongoing calls from first base repeater to one or more second base repeaters upon determination of failure of the first base repeater

(75) Inventors: James J. Han, Naperville, IL (US); Yue Ma, Schaumburg, IL (US)

Correspondence Address: MOTOROLA, INC., 1303 EAST ALGONQUIN ROAD, IL01/3RD, SCHAUMBURG, IL, 60196

(73) Assignee: MOTOROLA, INC.

(21) Appl. No.: 09/768,123

(22) Filed: Jan. 23, 2001

(51) Int. Cl. H04Q 7/20; H04B 17/00; H04B 7/14; H04B 3/36; H04B 1/38; H04M 1/00

(52) U.S. Cl. 455/423; 455/67.1; 455/8; 455/560

(57) ABSTRACT

A controller component of a system switches one or more ongoing calls from a first base repeater to one or more second base repeaters upon a determination of failure of the first base repeater. The first base repeater is different from each of the one or more second base repeaters.

### TECHNICAL FIELD

The invention in one embodiment relates generally to telecommunications and more particularly to failure of a base repeater that had been communicating a call.

### BACKGROUND

A number of mobile subscribers in one example of a system employ respective mobile stations to place calls on a channel. The system in one example comprises a time division multiple access (“TDMA”) system. For example, the system separates multiple conversation transmissions over a finite frequency allocation of through-the-air bandwidth. For example, the system allocates a discrete amount of frequency bandwidth to each mobile station, to permit multiple simultaneous conversations. For instance, the system assigns each caller a specific time slot for transmission, as will be understood by those skilled in the art.

A number of base repeaters of the system serve to communicate the calls. One or more of the base repeaters in one example experience a transient failure or a permanent failure. As one shortcoming of the system, ongoing calls handled by the one or more base repeaters that failed get dropped. The dropping of ongoing calls serves to disadvantageously irritate one or more parties to the call.

Thus, a need exists for enhanced handling of an ongoing call upon failure of a base repeater. A further need exists for enhanced handling of multiple ongoing calls upon failure of one or more base repeaters. Another need exists for enhanced reliability of support of one or more calls from one or more mobile stations.

### SUMMARY

Pursuant to one embodiment of the invention, shortcomings of the existing art are overcome and additional advantages are provided through the provision switching of one or more ongoing calls from a first base repeater to one or more second base repeaters upon a determination of failure of the first base repeater.

The invention in one embodiment encompasses a method. One or more ongoing calls are switched from a first base repeater to one or more second base repeaters upon a determination of failure of the first base repeater. The first base repeater is different from each of the one or more second base repeaters.

Another embodiment of the invention encompasses a system. The system includes a controller component that switches one or more ongoing calls from a first base repeater to one or more second base repeaters upon a determination of failure of the first base repeater. The first base repeater is different from each of the one or more second base repeaters.

A further embodiment of the invention encompasses an article. The article includes a computer-readable signal-bearing medium. The article includes means in the medium for switching one or more ongoing calls from a first base repeater to one or more second base repeaters upon a determination of failure of the first base repeater. The first base repeater is different from each of the one or more second base repeaters.

These and other features and advantages of one embodiment of the invention will become apparent from the following detailed description, the accompanying drawings, and the claims.

### BRIEF DESCRIPTION OF THE DRAWINGS

FIG. 1 is a functional block diagram of one example of a system that includes one or more instances of mobile subscriber, one or more instances of mobile station, one or more instances of base station, one or more instances of base station controller, one or more instances of mobile switching center, and one or more instances of network, illustrating one example in which one or more instances of the base station include a base repeater controller and one or more instances of base repeater.

FIG. 2 represents illustrative details of one example of a base repeater controller and one or more instances of a base repeater of the system of FIG. 1.

FIG. 3 represents one example of logic employed by one example of a base repeater controller of the system of FIG. 1.

FIG. 4 represents another example of logic employed by one example of a base repeater controller of the system of FIG. 1.

FIG. 5 represents a further example of logic employed by one example of a base repeater controller of the system of FIG. 1.

### DETAILED DESCRIPTION

In one embodiment of the invention, one or more ongoing calls are switched from a first base repeater to one or more second base repeaters upon a determination of failure of the first base repeater.

A detailed discussion of one exemplary embodiment of the invention is presented herein, for illustrative purposes.

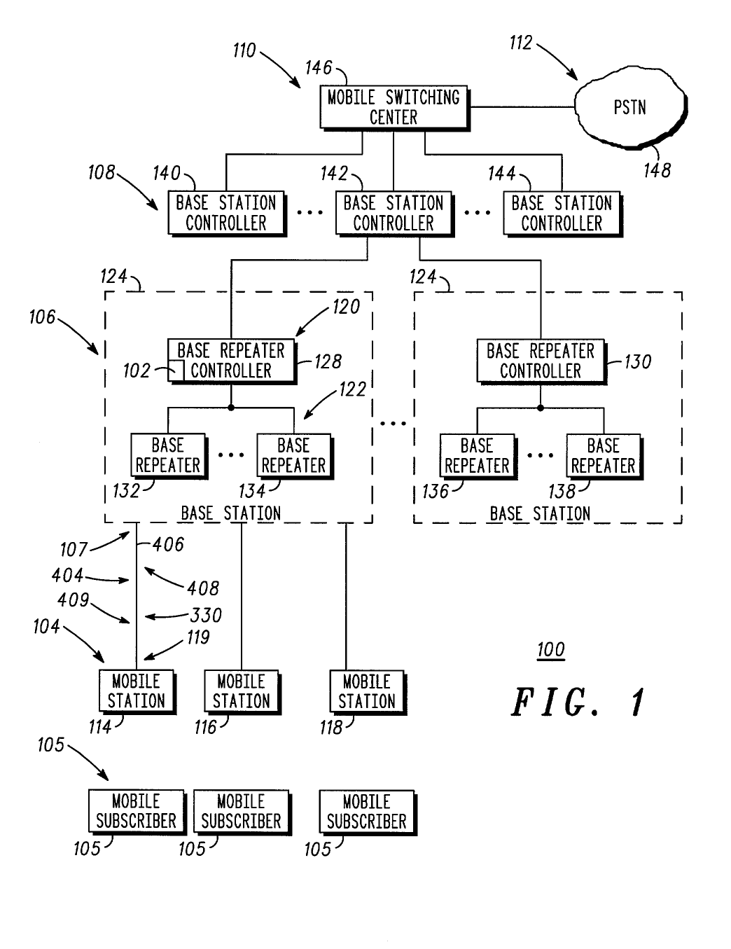

Turning to FIG. 1, system 100, in one example, includes a plurality of components such as computer software and/or hardware components. A number of such components can be combined or divided in one example of system 100. System 100 in one example employs at least one computer-readable signal-bearing medium. One example of a computer-readable signal-bearing medium for system 100 comprises an instance of recordable data storage medium 102 such as one or more of a magnetic, optical, biological, and atomic data storage medium. In another example, a computer-readable signal-bearing medium for system 100 comprises a modulated carrier signal transmitted over a network comprising or coupled with system 100, for instance, one or more of a telephone network, a local area network (“LAN”), the Internet, and a wireless network. An exemplary component of system 100 employs and/or comprises a series of computer instructions written in or implemented with any of a number of programming languages, as will be appreciated by those skilled in the art.

Referring again to FIG. 1, system 100 in one example comprises one or more components, for example, one or more instances of mobile station (“MS”) 104, one or more instances of mobile subscriber (“MS”) 105, one or more instances of base station (“BS”) 106, one or more instances of passage 107, one or more instances of base station controller (“BSC”) 108, one or more instances of mobile switching center (“MSC”) 110, and one or more instances of network 112.

Still referring to FIG. 1, mobile station 104 in one example comprises one or more of a cellular telephone, a wireless device, and a mobile telephone. Exemplary instances of mobile station 104 comprise mobile stations 114, 116, and 118. Mobile subscriber 105 in one example comprises a human operator. In one example, one or more instances of mobile subscriber 105 employ one or more instances of mobile station 104 to participate (e.g., place or receive) an instance of call 119 such as an instance of ongoing call (“OC”) 330. For example, mobile subscriber 105 comprises an instance of party 109 to an instance of call 119, as will be appreciated by those skilled in the art.

Referring further to FIG. 1, base station 106 in one example comprises one or more instances of base repeater controller (“BRC”) 120 and one or more instances of base repeater (“BR”) 122. Exemplary instances of base station 106 comprise base stations 124 and 126.

Referring still to FIG. 1, passage 107 in one example comprises a communications passage. In one example, passage 107 comprises a number of portions of one or more instances of a wireless path. One exemplary instance of passage 107 comprises one or more of transmission link 404, radio link 406, channel 408, and frequency 409, as will be appreciated by those skilled in the art.

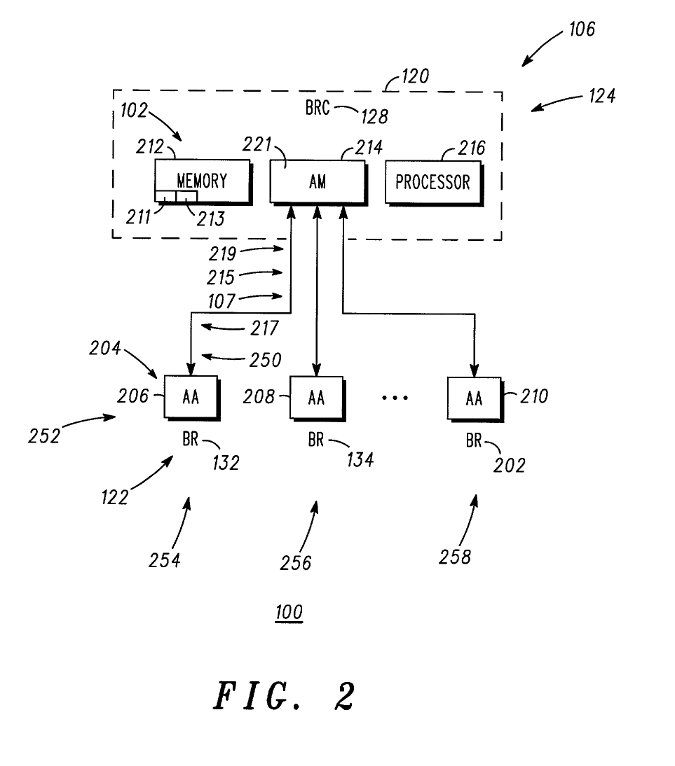

Now referring to FIGS. 1-2, base repeater controller 120 in one example comprises memory 212, availability manager (“AM”) 214, and processor 216. Memory 212 in one example comprises one exemplary instance of computer-readable signal-bearing medium 102. Exemplary instances of base repeater controller 120 comprise base repeater controllers 128 and 130.

Referring again to FIGS. 1-2, base repeater 122 in one example comprises availability agent (“AA”) 204. Exemplary instances of base repeater 122 comprise base repeaters 132, 134, 136, 138, and 202. Exemplary instances of availability agent 204 comprise availability agents 206, 208, and 210.

In one example, referring to FIGS. 1-2, memory 212 of base repeater controller 120 serves to store an instance of run-time record 211 for each instance of base repeater 122 of a particular instance of base station 106. In a further example, availability manager 214 serves to maintain status 213 of availability for each instance of base repeater 122 of the particular instance of base station 106. For example, availability manager 214 serves to monitor one or more instances of base repeater 122 to obtain a determination of successful or failed operation of any (e.g., particular one or more) of the one or more instances of base repeater 122.

In a still further example, referring to FIGS. 1-2, availability manager 214 sends (e.g., periodically) an instance of message 215 to each instance of availability agent 204 of the particular instance of base station 106. Upon receiving an instance of message 215 from an instance of availability manager 214, availability agent 204 in one example sends an instance of acknowledgement message 217 to the instance of availability manager 214.

In another example, referring to FIGS. 1-2, if availability manager 214 fails to receive an instance of acknowledgement message 217 from an instance of availability agent 204 within threshold time interval 221 after availability manager 214 has sent an instance of message 215 to the instance of availability agent 204, then availability manager 214 determines that an instance of base repeater 122 that comprises the instance of availability agent 204 has failed.

In yet another example, referring to FIGS. 1-2, availability agent 204 sends (e.g., periodically) an instance of status message 219 to availability manager 214. Status message 219 in one example comprises an “I am working” message. Availability manager 214 in one example waits (e.g., passively) for receipt of an instance of status message 219 from an instance of availability agent 204. If availability manager 214 fails to receive an instance of status message 219 from a certain instance of availability agent 204 within any instance of threshold time interval 221, then availability manager 214 determines that an instance of base repeater 122 that comprises the certain instance of availability agent 204 has failed.

Referring further to FIGS. 1-2, in one example, a determination by availability manager 214 that an instance of base repeater 122 has failed is based on a transient failure (e.g., temporary blockage) of the instance of base repeater 122. In another example, a determination by availability manager 214 that an instance of base repeater 122 has failed is based on a permanent failure (e.g., fatal error or breakage) of the instance of base repeater 122.

Still referring to FIGS. 1-2, in one example, upon a determination by an instance of availability manager 214 that an instance of base repeater 122 has failed, an instance of base repeater controller 120 that comprises the instance of availability manager 214 serves to switch (e.g., directly or indirectly) one or more instances of ongoing call 330 from the instance of base repeater 122 to one or more other instances of base repeater 122 that are each different from the failed instance of base repeater 122. In one example, the instance of base repeater controller 120 serves to switch (e.g., directly or indirectly) an instance of ongoing call 330 from the failed instance of base repeater 122 to an instance of base repeater 122 of an instance of base station 106 that comprises the failed instance of base repeater 122. In another example, the instance of base repeater controller 120 serves to switch (e.g., directly or indirectly) an instance of ongoing call 330 from the failed instance of base repeater 122 to an instance of base repeater 122 of an instance of base station 106 that differs from an instance of base station 106 that comprises the failed instance of base repeater 122. The instance of base repeater controller 120 in one example switches one or more instances of ongoing call 330 among one or more instances of base repeater 122 through employment of communication (e.g., direct or indirect) with one or more instances of base station controller 142 and/or one or more other instances of base repeater controller 120, for example, of one or more other instances of base station 106.

So, in one example, referring to FIGS. 1-2, system 100 employs an instance of base repeater 122 during a first instance of time interval 250 to communicate one or more instances of ongoing call 330 at an instance of frequency 409, and system 100 employs one or more other instances of base repeater 122 during a second instance of time interval 250 to communicate the one or more instances of ongoing call 330 at the instance of frequency 409. For example, the second instance of time interval 250 is subsequent to the first instance of time interval 250.

Referring further to FIGS. 1-2, system 100 serves to switch one or more instances of ongoing call 330 among a plurality of instances of base repeater 122 through employment of one or more instances of frequency 409 that are employable for one or more handoffs of the one or more instances of ongoing call 330 from a first instance of cell 252 to one or more second instances of cell 252. For example, the first instance of cell 252 is different from each of the one or more second instances of cell 252. Exemplary instances of cell 252 comprise cells 254, 256, and 258. In one example, adjacent instances of base repeater 122 employ different instances of frequency 409, as will be appreciated by those skilled in the art.

Again referring to FIGS. 1-2, base repeater controller 120 serves to switch (e.g., directly or indirectly) one or more instances of ongoing call 330 from an instance of base repeater 122 to one or more other instances of base repeater 122 substantially transparently relative to one or more instances of party 109 to the one or more instances of ongoing call 330.

Referring to FIG. 1, exemplary instances of base station controller 108 comprise base station controllers 140, 142, and 144. One exemplary instance of mobile switching center 110 comprises mobile switching center 146. One exemplary instance of network 112 comprises public switched telephone network (“PSTN”) 148.

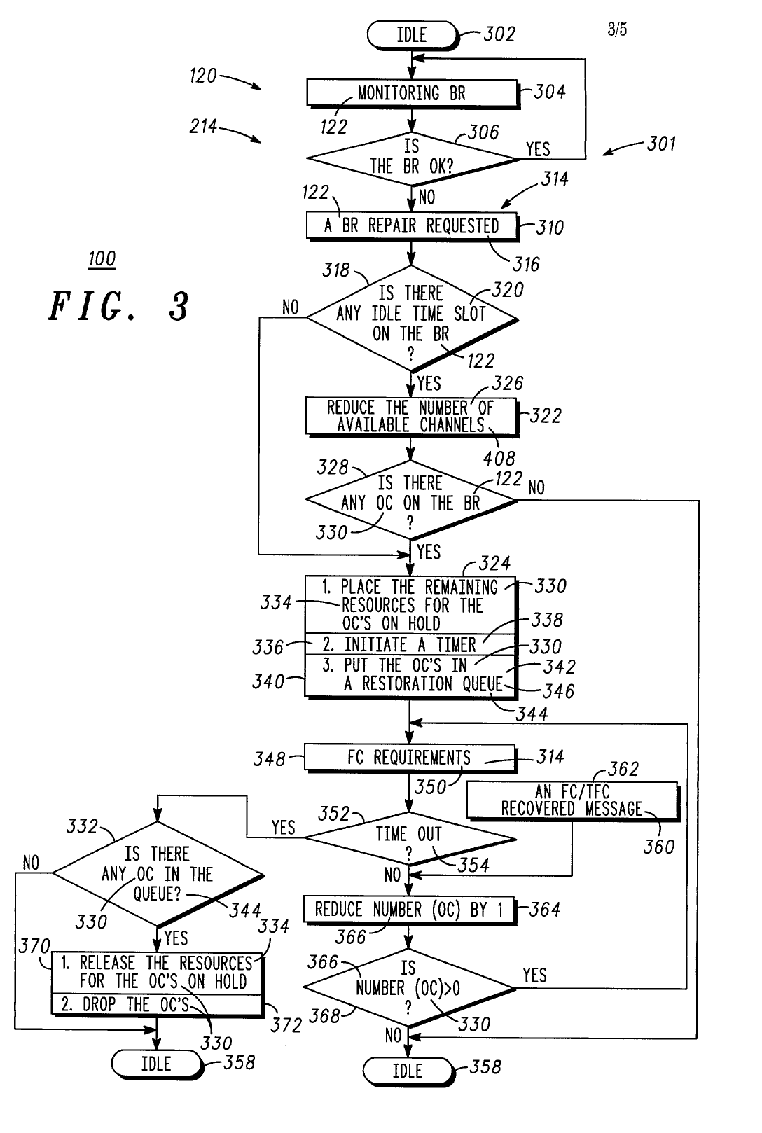

Turning to FIG. 3, base repeater controller 120 in one example employs exemplary logic 301. For example, availability manager 214 of base repeater controller 120 employs exemplary logic 301.

Again referring to FIG. 3, at STEP 302 in one example availability manager 214 is idle. STEP 302 in one example proceeds to STEP 304. At STEP 304 in one example availability manager 214 monitors an instance of base repeater 122. STEP 304 in one example proceeds to STEP 306.

Still referring to FIG. 3, at STEP 306 in one example availability manager 214 determines whether or not the instance of base repeater 122 is in working condition. For example, at STEP 306 availability manager 214 makes a determination of whether or not the instance of base repeater 122 has failed, for example, in operation. In one example, STEP 306 determines that the instance of base repeater 122 is in working condition, and therefore proceeds to STEP 304. In another example, STEP 306 determines that the instance of base repeater 122 is not in working condition, and therefore proceeds to STEP 310.

Further referring to FIG. 3, at STEP 310 in one example base repeater controller 120 sends request 314 to, for example, an instance of base station controller 108 (FIG. 1). Request 314 in one example comprises repair request 316 for the instance of base repeater 122. STEP 310 in one example proceeds to STEP 318.

Referring again to FIG. 3, at STEP 318 in one example base repeater controller 120 determines whether or not any instance of time slot 320 on the instance of base repeater 122 is idle. In one example, STEP 318 determines that an instance of time slot 320 on the instance of base repeater 122 is idle, and therefore proceeds to STEP 322. In another example, STEP 318 determines that no instance of time slot 320 on the instance of base repeater 122 is idle, and therefore proceeds to STEP 324.

Referring still to FIG. 3, at STEP 322 in one example base repeater controller 120 reduces count 326. Count 326 in one example comprises a count of number of available instances of time slot 320 on the instance of base repeater 122. STEP 322 in one example proceeds to STEP 328.

Referring again to FIG. 3, at STEP 328 in one example base repeater controller 120 makes a determination of whether or not any instance of ongoing call 330 exists on the instance of base repeater 122. In one example, STEP 328 determines that an instance of ongoing call 330 exists on the instance of base repeater 122, and therefore proceeds to STEP 324. In another example, STEP 328 determines that no instance of ongoing call 330 exists on the instance of base repeater 122, and therefore proceeds to STEP 358. At the STEP 358 in one example exemplary logic 301 is idle.

Further referring to FIG. 3, at STEP 324 in one example base repeater controller 120 places on hold instances of resource 334 other than radio frequency (“RF”) portion of resource 334. STEP 324 in one example proceeds to STEP 336. At STEP 336 in one example base repeater controller 120 initiates an instance of timer 338. STEP 336 in one example proceeds to STEP 340. At STEP 340 in one example base repeater controller 120 places one or more instances of ongoing calls 330 in an instance of storage 342. Storage 342 in one example comprises queue 344, for example, restoration queue 346. STEP 340 in one example proceeds to STEP 348.

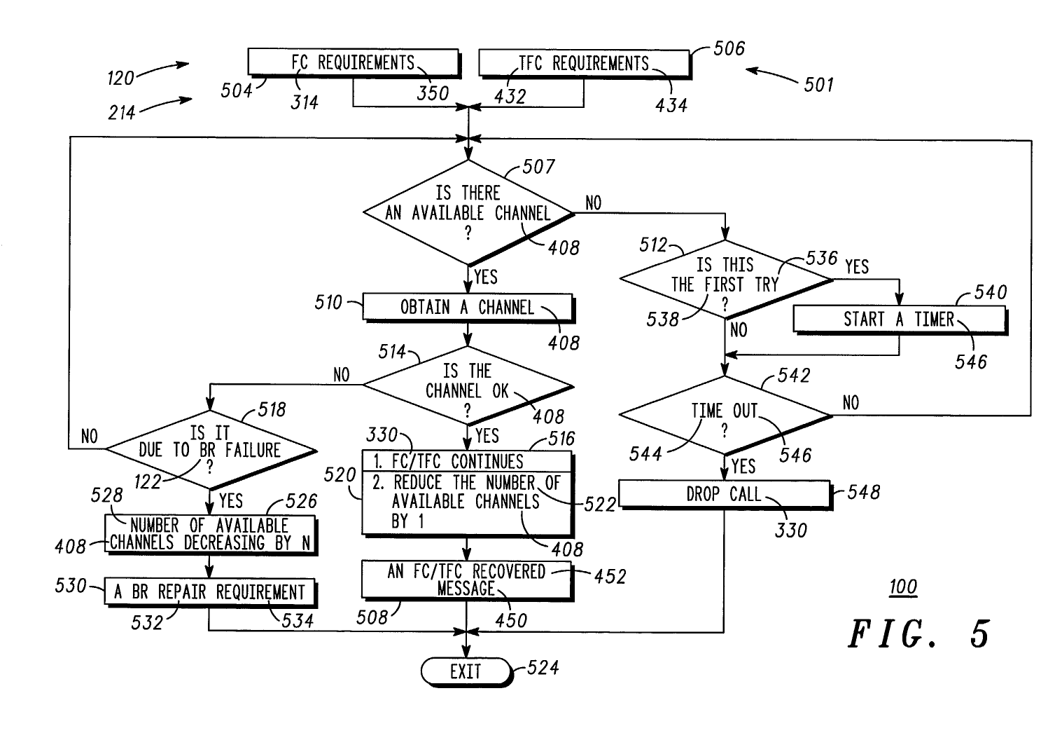

Still referring to FIG. 3, at STEP 348 in one example base repeater controller 120 sends an instance of request 314. For example, STEP 348 sends failed call (“FC”) request 350, for example, to STEP 504 of exemplary logic 501 (FIG. 5). STEP 348 in one example proceeds to STEP 352.

Referring again to FIG. 3, at STEP 352 in one example base repeater controller 120 checks whether or not time out event 354 has occurred. For example, STEP 352 periodically performs check 356 of whether or not time out event 354 has occurred. In one example, STEP 352 determines that time out event 354 has occurred, and therefore proceeds to STEP 332.

Referring again to FIG. 3, at STEP 332 in one example base repeater controller 120 determines whether or not any instance of ongoing call 330 exists in queue 344. In one example, STEP 332 determines that no instance of ongoing call 330 exists in queue 344, and therefore proceeds to STEP 358. In another example, STEP 332 determines that one or more instances of ongoing call 330 exist in queue 344, and therefore proceeds to STEP 370. At STEP 370 in one example base repeater controller 120 releases instances of resource 334 for the instances of ongoing call 330 that are on hold. STEP 370 in one example proceeds to STEP 372. At STEP 372 in one example base repeater controller 120 drops the instances of ongoing call 330. STEP 372 in one example proceeds to STEP 358. STEP 332 in one example proceeds to STEP 358.

Again referring to FIG. 3, in another example, STEP 352 determines that time out event 354 has not occurred. In addition, base repeater controller 120 determines that an instance of failed called/transient failed called (“FC/TFC”) recovered message 360 has arrived, for example, as an instance of arrival event 362. Upon a determination by STEP 352 that time out event 354 has not occurred and upon an occurrence of arrival event 362, base repeater controller 120 in one example proceeds to STEP 364.

Still referring to FIG. 3, at STEP 364 in one example base repeater controller 120 reduces count 366 of instances of ongoing call 330 by one. STEP 364 in one example proceeds to STEP 368.

Referring further to FIG. 3, at STEP 368 in one example base repeater controller 120 determines whether or not count 366 of instances of ongoing call 330 is greater than zero. In one example, STEP 368 determines that count 366 of instances of ongoing call 330 is greater than zero, and therefore proceeds to STEP 348. In another example, STEP 368 determines that count 366 of instances of ongoing call 330 is not greater than zero, and therefore proceeds to STEP 358.

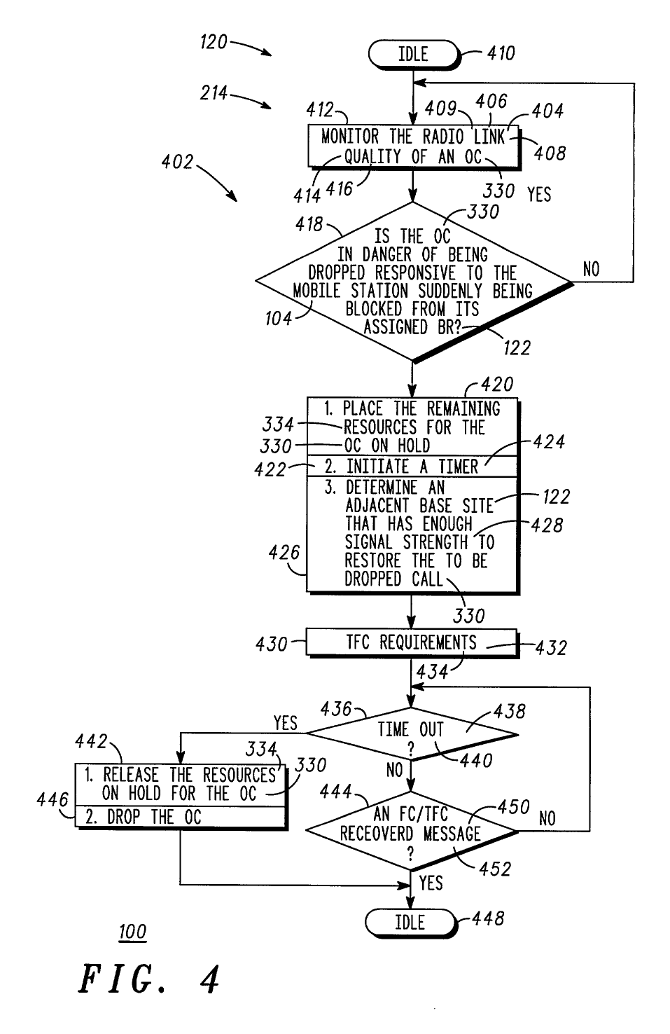

Turning to FIG. 4, system 100 in one example employs exemplary logic 402. Exemplary logic 402 in one example comprises logic that availability manager 214 of base repeater controller 120 employs, for example, to prevent system 100 from suddenly dropping an instance of ongoing call 330 upon blockage of an instance of transmission link 404 between an instance of mobile station 104 (FIG. 1) and an instance of base repeater 122 that system 100 has assigned to the instance of mobile station 104. Transmission link 404 in one example comprises radio link 406.

Again referring to FIG. 4, at STEP 410 in one example availability manager 214 is idle. For example, at STEP 410 availability manager 214 awaits system 100 to assign a working instance of link 404 to an instance of ongoing call 330. In one example, base repeater controller 120 serves to assign a working instance of link 404 to the instance of ongoing call 330. STEP 410 in one example proceeds to STEP 412.

Again referring to FIG. 4, at STEP 412 in one example availability manager 214 monitors quality 414 of the instance of link 406 for the instance of ongoing call 330. Quality 414 in one example comprises radio link quality for the instance of ongoing call 330. STEP 412 in one example proceeds to STEP 418.

Still referring to FIG. 4, at STEP 418 in one example availability manager 214 determines whether or not the instance of ongoing call 330 is in danger of being dropped by an instance of base repeater 122, that system 100 has assigned to the instance of ongoing call 330, in the event of blockage of an instance of link 404 between the instance of base repeater 122 and an instance of mobile station 104 that participates in the instance of ongoing call 330. In one example, STEP 418 determines that the instance of ongoing call 330 is not in danger of being dropped, and therefore proceeds to STEP 412. In another example, STEP 418 determines that the instance of ongoing call 330 is in danger of being dropped, and therefore proceeds to STEP 420.

Referring still to FIG. 4, at STEP 420 in one example base repeater controller 120 places on hold instances of resource 334 for the instance of ongoing call 330. STEP 420 in one example proceeds to STEP 422. At STEP 422 in one example base repeater controller 120 initiates an instance of timer 424 of system 100. STEP 422 in one example proceeds to STEP 426.

Again referring to FIG. 4, at STEP 426 in one example base repeater controller 120 identifies an instance base repeater 122 that comprises a sufficient level of signal strength 428 to allow restoration of the instance of ongoing call 330 that is in danger of being dropped. STEP 426 in one example proceeds to STEP 430.

Further referring to FIG. 4, at STEP 430 in one example base repeater controller 120 sends an instance of request 432 to STEP 506 (FIG. 5) of exemplary logic 501 (FIG. 5). Request 432 in one example comprises transient failed call (“TFC”) request 434. STEP 430 in one example proceeds to STEP 436.

Referring still to FIG. 4, at STEP 436 in one example base repeater controller 120 checks for an occurrence of event 438. For example, STEP 436 periodically checks for an occurrence of event 438. Event 438 in one example comprises time out event 440.

Still referring to FIG. 4, in one example, STEP 436 determines that event 438 has occurred, and therefore proceeds to STEP 442. In another example, STEP 436 determines that event 438 has not occurred, and therefore proceeds to STEP 444.

Referring still to FIG. 4, at STEP 442 (e.g., from STEP 436) in one example base repeater controller 120 releases the instances of resource 334 previously placed on hold for the instance of ongoing call 330. STEP 442 in one example proceeds to STEP 446. At STEP 446 in one example availability manager 214 drops the instance of ongoing call 330. STEP 446 in one example proceeds to STEP 448.

Again referring to FIG. 4, at STEP 448 in one example availability manager 214 is idle.

Referring further to FIG. 4, at STEP 444 (e.g., from STEP 436) in one example, base repeater controller 120 determines whether or not an instance of message 450 has been obtained in system 100. For example, STEP 444 determines whether or not STEP 508 (FIG. 5) of exemplary logic 501 (FIG. 5) has output an instance of message 450. Message 450 in one example comprises failed call/transient failed call recovered message 452. In one example, STEP 444 determines that no instance of message 450 has been obtained, and therefore proceeds to STEP 436. In another example, STEP 444 determines that an instance of message 450 has been obtained, and therefore proceeds to STEP 448.

Turning to FIG. 5, system 100 in one example employs exemplary logic 501. Exemplary logic 501 in one example comprises logic that allows recovery of a number of failed calls and/or transient failed calls.

Again referring to FIG. 5, at STEP 504 in one example base repeater controller 120 receives an instance of request 315, for example, from STEP 348 (FIG. 3) of exemplary logic 301 (FIG. 3). For example, STEP 348 sends failed call request 350 to STEP 504.

Still referring to FIG. 5, at STEP 506 in one example base repeater controller 120 receives an instance of request 432, for example, from STEP 430 (FIG. 4) of exemplary logic 402 (FIG. 4). For example, STEP 430 sends transient failed call request 434 to STEP 506.

Further referring to FIG. 5, STEP 504 or STEP 506 in one example proceeds to STEP 507. At STEP 507 in one example base repeater controller 120 determines whether or not an instance of channel 408 is available. In one example, STEP 507 determines that an instance of channel 408 is available, and therefore proceeds to STEP 510. In another example, STEP 507 determines that no instance of channel 408 is available, and therefore proceeds to STEP 512.

Referring again to FIG. 5, at STEP 510 in one example base repeater controller 120 obtains an instance of channel 408. STEP 510 in one example proceeds to STEP 514.

Referring further to FIG. 5, at STEP 514 in one example availability manager 214 determines whether or not the instance of channel 408 that STEP 510 obtained, is in working condition. In one example, STEP 514 determines that the instance of channel 408 is in working condition, and therefore proceeds to STEP 516. In another example, STEP 514 determines that the instance of channel 408 is not in working condition, and therefore proceeds to STEP 518.

Referring still to FIG. 5, at STEP 516 (e.g., from STEP 514) base repeater controller 120 in one example allows the instance of ongoing call 330 to continue on the instance of channel 408 (e.g., obtained in STEP 510). STEP 516 in one example proceeds to STEP 520. At STEP 520 in one example, base repeater controller 120 reduces count 522 of available instances of channel 408, by one. STEP 520 in one example proceeds to STEP 508.

Further referring to FIG. 5, at STEP 508 in one example base repeater controller 120 sends an instance of message 450. In one example, STEP 508 sends an instance of message 450 to STEP 444 (FIG. 4) of exemplary logic 402 (FIG. 4). For example, STEP 508 sends failed call/transient failed call recovered message 452 to STEP 444. STEP 508 in one example proceeds to STEP 524.

Referring again to FIG. 5, at STEP 524 in one example base repeater controller 120 exits exemplary logic 501.

Referring still to FIG. 5, at STEP 518 (e.g., from STEP 514) in one example base repeater controller 120 determines whether or not a failure of an instance of base repeater 122 has caused the instance of channel 408 to fail. In one example, STEP 518 determines that the failure of the instance of channel 408 is not due to a failure of an instance of base repeater 122, and therefore proceeds to STEP 507. In another example, STEP 518 determines that a failure of an instance of base repeater 122 caused a failure of the instance of channel 408, and therefore proceeds to STEP 526.

Again referring to FIG. 5, at STEP 526 in one example base repeater controller 120 decreases by N count 528 of available instances of channel 408. N in one example equals a capacity of an instance of base repeater 122 for carrying instances of channel 408. STEP 526 in one example proceeds to STEP 530.

Further referring to FIG. 5, at STEP 530 in one example base repeater controller 120 sends an instance of request 532. Request 532 in one example comprises base repeater repair request 534. STEP 530 in one example proceeds to STEP 524.

Referring still to FIG. 5, at STEP 512 (e.g., from STEP 507) in one example base repeater controller 120 determines whether or not a present instance of iteration 536 comprises initial iteration 538. In one example, STEP 512 determines that the present instance of iteration 536 comprises initial iteration 538, and therefore proceeds to STEP 540. In another example, STEP 512 determines that the present instance of iteration 536 does not comprise initial iteration 538, and therefore proceeds to STEP 542. For example, STEP 512 determines that the present instance of iteration 536 comprises an instance of iteration 536 subsequent to initial iteration 538, and therefore proceeds to STEP 542.

Again referring to FIG. 5, at STEP 540 (e.g., from STEP 512) base repeater controller 120 in one example starts an instance of timer 546. STEP 540 in one example proceeds to STEP 542.

Referring further to FIG. 5, at STEP 542 in one example base repeater controller 120 determines whether or not an instance of event 544 has occurred. Event 544 in one example comprises time out event 546. In one example, STEP 542 determines that an occurrence of an instance of event 544 has not occurred, and therefore proceeds to STEP 507. In another example, STEP 542 determines that an instance of event 544 has occurred, and therefore proceeds to STEP 548.

Referring still to FIG. 5, at STEP 548 in one example base repeater controller 120 drops the instance of ongoing call 330. STEP 548 in one example proceeds to STEP 524.

The flow diagrams depicted herein are just exemplary. There may be many variations to these diagrams or the steps or operations described therein without departing from the spirit of the invention. For instance, the steps may be performed in a differing order, or steps may be added, deleted, or modified.

Although exemplary embodiments of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. A method, comprising the step of:
switching one or more ongoing calls from a first base repeater to one or more second base repeaters upon a determination of failure of the first base repeater, wherein the first base repeater is different from each of the one or more second base repeaters.

2. The method of claim 1, wherein the one or more ongoing calls comprise a first ongoing call and a second ongoing call, wherein the step of switching the one or more ongoing calls from the first base repeater to the one or more second base repeaters upon the determination of failure of the first base repeater comprises the steps of:
switching the first ongoing call from the first base repeater to a base repeater of the one or more second base repeaters upon the determination of failure of the first base repeater; and
switching the second ongoing call from the first base repeater to a base repeater of the one or more second base repeaters upon the determination of failure of the first base repeater.

3. The method of claim 1, wherein the one or more ongoing calls comprise a first ongoing call and a second ongoing call, wherein the step of switching the one or more ongoing calls from the first base repeater to the one or more second base repeaters upon the determination of failure of the first base repeater comprises the steps of:
employing the first base repeater during a first time interval to communicate the first ongoing call at a frequency and communicate the second ongoing call at the frequency; and
employing one or more of the one or more second base repeaters during a second time interval to communicate the first ongoing call at the frequency and communicate the second ongoing call at the frequency, wherein the second time interval is subsequent to the first time interval.

4. The method of claim 1, wherein the step of switching the one or more ongoing calls from the first base repeater to the one or more second base repeaters upon the determination of failure of the first base repeater comprises the step of:
switching one or more of the one or more ongoing calls from the first base repeater to one or more of the one or more second base repeaters through employment of one or more frequencies that are employable for one or more handoffs of the one or more of the one or more ongoing calls from a first cell to one or more second cells, wherein the first cell is different from each of the one or more second cells.

5. The method of claim 1, wherein the step of switching the one or more ongoing calls from the first base repeater to the one or more second base repeaters upon the determination of failure of the first base repeater comprises the step of:
switching one or more of the one or more ongoing calls from the first base repeater to one or more of the one or more second base repeaters substantially transparently relative to one or more parties to the one or more of the one or more ongoing calls.

6. The method of claim 1, wherein the step of switching the one or more ongoing calls from the first base repeater to the one or more second base repeaters upon the determination of failure of the first base repeater comprises the step of:
switching one or more of the one or more ongoing calls from the first base repeater to one or more of the one or more second base repeaters upon a determination of failure that is based on a transient failure or a permanent failure of the first base repeater.

7. The method of claim 1, wherein the step of switching the one or more ongoing calls from the first base repeater to the one or more second base repeaters upon the determination of failure of the first base repeater comprises the step of:
monitoring the first base repeater to obtain the determination of failure of the first base repeater.

8. A system, comprising:
a controller component that switches one or more ongoing calls from a first base repeater to one or more second base repeaters upon a determination of failure of the first base repeater, wherein the first base repeater is different from each of the one or more second base repeaters.

9. The system of claim 8, wherein the one or more ongoing calls comprise a first ongoing call and a second ongoing call, wherein the controller component that switches the one or more ongoing calls from the first base repeater to the one or more second base repeaters upon the determination of failure of the first base repeater comprises:
a controller component that switches the first ongoing call from the first base repeater to a base repeater of the one or more second base repeaters upon the determination of failure of the first base repeater; and
a controller component that switches the second ongoing call from the first base repeater to a base repeater of the one or more second base repeaters upon the determination of failure of the first base repeater.

10. The system of claim 8, wherein the one or more ongoing calls comprise a first ongoing call and a second ongoing call, wherein the controller component that switches the one or more ongoing calls from the first base repeater to the one or more second base repeaters upon the determination of failure of the first base repeater comprises:
a controller component that employs the first base repeater during a first time interval to communicate the first ongoing call at a frequency and communicate the second ongoing call at the frequency; and
a controller component that employs one or more of the one or more second base repeaters during a second time interval to communicate the first ongoing call at the frequency and communicate the second ongoing call at the frequency, wherein the second time interval is subsequent to the first time interval.

11. The system of claim 8, wherein the controller component that switches the one or more ongoing calls from the first base repeater to the one or more second base repeaters upon the determination of failure of the first base repeater comprises:
a controller component that switches one or more of the one or more ongoing calls from the first base repeater to one or more of the one or more second base repeaters through employment of one or more frequencies that are employable for one or more handoffs of the one or more of the one or more ongoing calls from a first cell to one or more second cells, wherein the first cell is different from each of the one or more second cells.

12. The system of claim 8, wherein the controller component that switches the one or more ongoing calls from the first base repeater to the one or more second base repeaters upon the determination of failure of the first base repeater comprises:
a controller component that switches one or more of the one or more ongoing calls from the first base repeater to one or more of the one or more second base repeaters substantially transparently relative to one or more parties to the one or more of the one or more ongoing calls.

13. The system of claim 8, wherein the controller component that switches the one or more ongoing calls from the first base repeater to the one or more second base repeaters upon the determination of failure of the first base repeater comprises:
a controller component that switches one or more of the one or more ongoing calls from the first base repeater to one or more of the one or more second base repeaters upon a determination of failure that is based on a transient failure or a permanent failure of the first base repeater.

14. The system of claim 8, wherein the controller component that switches the one or more ongoing calls from the first base repeater to the one or more second base repeaters upon the determination of failure of the first base repeater comprises:
a controller component that monitors the first base repeater to obtain the determination of failure of the first base repeater.

15. An article, comprising:
a computer-readable signal-bearing medium; and
means in the medium for switching one or more ongoing calls from a first base repeater to one or more second base repeaters upon a determination of failure of the first base repeater, wherein the first base repeater is different from each of the one or more second base repeaters.

16. The article of claim 15, wherein the one or more ongoing calls comprise a first ongoing call and a second ongoing call, wherein the means in the medium for switching the one or more ongoing calls from the first base repeater to the one or more second base repeaters upon the determination of failure of the first base repeater comprises:
means in the medium for switching the first ongoing call from the first base repeater to a base repeater of the one or more second base repeaters upon the determination of failure of the first base repeater; and
means in the medium for switching the second ongoing call from the first base repeater to a base repeater of the one or more second base repeaters upon the determination of failure of the first base repeater.

17. The article of claim 15, wherein the one or more ongoing calls comprise a first ongoing call and a second ongoing call, wherein the means in the medium for switching the one or more ongoing calls from the first base repeater to the one or more second base repeaters upon the determination of failure of the first base repeater comprises:
means in the medium for employing the first base repeater during a first time interval to communicate the first ongoing call at a frequency and communicate the second ongoing call at the frequency; and
means in the medium for employing one or more of the one or more second base repeaters during a second time interval to communicate the first ongoing call at the frequency and communicate the second ongoing call at the frequency, wherein the second time interval is subsequent to the first time interval.

18. The article of claim 15, wherein the means in the medium for switching the one or more ongoing calls from the first base repeater to the one or more second base repeaters upon the determination of failure of the first base repeater comprises:
means in the medium for switching one or more of the one or more ongoing calls from the first base repeater to one or more of the one or more second base repeaters through employment of one or more frequencies that are employable for one or more handoffs of the one or more of the one or more ongoing calls from a first cell to one or more second cells, wherein the first cell is different from each of the one or more second cells.

19. The article of claim 15, wherein the means in the medium for switching the one or more ongoing calls from the first base repeater to the one or more second base repeaters upon the determination of failure of the first base repeater comprises:
means in the medium for switching one or more of the one or more ongoing calls from the first base repeater to one or more of the one or more second base repeaters substantially transparently relative to one or more parties to the one or more of the one or more ongoing calls.

20. The article of claim 15, wherein the means in the medium for switching the one or more ongoing calls from the first base repeater to the one or more second base repeaters upon the determination of failure of the first base repeater comprises:
means in the medium for switching one or more of the one or more ongoing calls from the first base repeater to one or more of the one or more second base repeaters upon a determination of failure that is based on a transient failure or a permanent failure of the first base repeater.

21. The article of claim 15, wherein the means in the medium for switching the one or more ongoing calls from the first base repeater to the one or more second base repeaters upon the determination of failure of the first base repeater comprises:
means in the medium for monitoring the first base repeater to obtain the determination of failure of the first base repeater.
